(19) United States
(12) Patent Application Publication
(10) Pub. No.: US 2023/0010832 A1
(43) Pub. Date: Jan. 12, 2023

(54) LIQUID CANDLE DYE AND METHOD FOR PRODUCING LIQUID CANDLE DYE

(71) Applicant: HUNAN SIJIU TECHNOLOGY CO., LTD, CHANGSHA CITY (CN)

(72) Inventor: MIN AI, CHANGSHA CITY (CN)

(21) Appl. No.: 17/370,006

(22) Filed: Jul. 8, 2021

(51) Int. Cl. C11C 5/00; C09B 67/40; C09B 67/10; C09B 67/04

(52) U.S. Cl. CPC C11C 5/004; C09B 67/0082; C09B 67/0014; C09B 67/0002

(57) ABSTRACT

A liquid candle dye and a method for producing liquid candle dye related to the field of dye technology are provided, wherein the liquid candle dye by weight comprises: 40˜80 parts of an oil-soluble dye; 30˜80 parts of a solvent; and 10-20 parts of an auxiliary agent. The method for producing liquid candle dye of which a preparation method is as follows is provided: step 1: preparing materials according to any one of claims 1 to 3; step 2: soaking the oil-soluble dye in the solvent to dissolve; step 3: putting a soaked mixture in step 2 into a stirring device for stirring and then filtering; and step 4: adding the auxiliary agent to a filtered mixture in step 3, stirring evenly, and then forming a finished product.

### FIELD OF THE DISCLOSURE

The present disclosure relates to the field of dye technology, in particular, to a liquid candle dye and a method for producing liquid candle dye.

### BACKGROUND OF THE DISCLOSURE

With the continuous improvement of people's pursuit of spiritual and cultural life, various types of handmade DIY are gradually developing, among which people's demand for homemade personalized candles is also increasing. However, at present, the dyes used for personal DIY to make colored candles are generally used in traditional industries solid or powdered dyes, these dyes are not easy for individual players to buy, and the operation is complicated, the amount and time of addition cannot be accurately controlled during use, and it is difficult to mix uniformly without mechanical equipment stirring, and powdered dyes are easier disperse, pollute the production environment, which is not suitable for DIY scenes of individual players. Therefore, it is necessary to develop a liquid candle dye that is easy to disperse in various wax liquids and has low requirements for operation technology.

### SUMMARY OF THE DISCLOSURE

The purpose of the present disclosure is to provide a liquid candle dye and a preparation method thereof in view of the defects and deficiencies of the prior art, which has the advantages of simple operation, easy control of the addition amount, good dispersion effect, high color saturation and transparency.

In order to achieve the above objective, the technical solution adopted by the present disclosure is as follows.

A liquid candle dye is provided, wherein the liquid candle dye by weight comprises: 40-80 parts of an oil-soluble dye; 30-80 parts of a solvent; and 10-20 parts of an auxiliary agent.

The solvent comprises liquid paraffin and isododecan, or isohexadecane.

The auxiliary agent comprises any one or more of stearamide, anti-settling agent and antifoaming agent.

The present disclosure further discloses a method for producing liquid candle dye, wherein a preparation method is as follows: step 1: preparing materials according to any one of above-mentioned disclosure; step 2: soaking the oil-soluble dye in the solvent to dissolve; step 3: putting a soaked mixture in step 2 into a stirring device for stirring and then filtering; and step 4: adding the auxiliary agent to a filtered mixture in step 3, stirring evenly, and then forming a finished product.

In a preferred embodiment, the method comprises: putting the soaked mixture in step 2 into the stirring device for stirring and then filtering, and putting the filtered mixture into a grinder for grinding.

In a preferred embodiment, the method comprises: putting the soaked mixture in step 2 into the stirring device for stirring and then filtering, wherein a temperature during stirring is maintained at 60° and a stirring time is 1.5 to 3.5hours.

In a preferred embodiment, the method comprises that: in step2, the oil-soluble dye is in the solvent for 2 to 5 hours.

After adopting the above technical solution, the present disclosure has the following beneficial effects. The present disclosure provides a liquid candle dye, which is convenient for users to use and operate, reduces the steps of crushing and stirring the solid or powdered dye when it is used. In addition, it avoids splashing of dyes during operation and polluting the candle making environment, and also reducing the difficulty of controlling the amount of addition, thereby helping to improve the success rate of DIY products and the controllability of dyeing depth.

Not only that, in the process of making candles, because the liquid dyes can be quickly dispersed in the wax liquid without long-term stirring, the making process of DIY candles is simpler, and the candles made will not affect the burning.

In addition, the present disclosure achieves the effects of high color saturation of the dye, high color transparency, good liquid viscosity, no precipitation and no separation after adding the auxiliary agent and after two stirring and one grinding.

### DETAILED DESCRIPTION OF THE EXEMPLARY EMBODIMENTS

This specific embodiment is only an explanation of the present disclosure, and it is not a limitation of the present disclosure. After reading this specification, those skilled in the art can make modifications to this embodiment that do not create any contribution as needed, but as long as the rights of the present disclosure. The scope of the requirements is protected by the patent law.

The liquid candle dye of the present disclosure is obtained by adopting an oil-soluble dye, using liquid paraffin and isododecane or isohexadecane as a solvent, and adding any one or more of stearamide, anti-settling agent and antifoaming agent. It has the advantages of simple operation, easy control of addition amount, good dispersion effect, high color saturation and transparency.

### Embodiment 1

This embodiment relates to a liquid candle dye, and the components and contents of which are as follows:

43 parts of oil-soluble red

30 parts of liquid paraffin

40 parts of isododecane

14 parts of stearamide

2 parts of anti-settling agent

1 part of defoamer

The preparation method of liquid candle dye is as follows.

Step 1: preparing materials according to the above ratio;

Step 2: soaking the oil-soluble red in isododecane and liquid paraffin for 3.5 hours for preliminary dissolution;

Step 3: putting the soaked mixture in step 2 into a stirring device, stirring for 2 hours and then filtering, and then putting the filtered mixture into a grinder to grind. Preferably, the temperature during stirring is maintained at 60°.

Step 4: adding anti-settling agent, anti-foaming agent and stearamide to the filtered mixture in step 3, stirring evenly, and then forming a finished product.

### Embodiment 2

This embodiment relates to a liquid candle dye, and the components and contents of which are as follows.

80 parts of titanium dioxide

10 parts of liquid paraffin

20 parts of isohexadecane

14 parts of stearamide

4 parts of anti-settling agent

1 part of defoamer

The preparation method of liquid candle dye is as follows.

Step 1: preparing materials according to the above ratio;

Step 2: soaking the titanium dioxide in isohexadecane and liquid paraffin for 3.5 hours for preliminary dissolution;

Step 3: putting the soaked mixture in step 2 into a stirring device, stirring for 2 hours and then filtering, and then putting the filtered mixture into a grinder to grind. Preferably, the temperature during stirring is maintained at 60°.

Step 4: adding anti-settling agent, anti-foaming agent and stearamide to the filtered mixture in step 3, stirring evenly, and then forming a finished product.

The above are only used to illustrate the technical solutions of the present disclosure and not to limit them. Other modifications or equivalent substitutions made by those of ordinary skill in the art to the technical solutions of the present disclosure shall be covered, and as long as they do not deviate from the spirit and scope of the technical solutions of the present disclosure, they shall be included within the scope of the claims of the present disclosure.

What is claimed is:

1. A liquid candle dye, wherein the liquid candle dye by weight comprises:
40-80 parts of an oil-soluble dye;
30-80 parts of a solvent; and
10-20 parts of an auxiliary agent.

2. The liquid candle dye according to claim 1, wherein the solvent comprises liquid paraffin and isododecane, or isohexadecane.

3. The liquid candle dye according to claim 2, wherein the auxiliary agent comprises any one or more of stearamide, anti-settling agent and antifoaming agent.

4. A method for producing liquid candle dye, comprising:
step 1: preparing materials according to claim 1;
step 2: soaking the oil-soluble dye in the solvent to dissolve;
step 3: putting a soaked mixture in step 2 into a stirring device for stirring and then filtering; and
step 4: adding the auxiliary agent to a filtered mixture in step 3, stirring evenly, and then forming a finished product.

5. A method for producing liquid candle dye, comprising:
step 1: preparing materials according to claim 2;
step 2: soaking the oil-soluble dye in the solvent to dissolve;
step 3: putting a soaked mixture in step 2 into a stirring device for stirring and then filtering; and
step 4: adding the auxiliary agent to a filtered mixture in step 3, stirring evenly, and then forming a finished product.

6. A method for producing liquid candle dye, comprising:
step 1: preparing materials according to claim 3;
step 2: soaking the oil-soluble dye in the solvent to dissolve;
step 3: putting a soaked mixture in step 2 into a stirring device for stirring and then filtering; and
step 4: adding the auxiliary agent to a filtered mixture in step 3, stirring evenly, and then forming a finished product.

7. The method for producing liquid candle dye according to claim 4, comprising: putting the soaked mixture in step 2 into the stirring device for stirring and then filtering, and putting the filtered mixture into a grinder for grinding.

8. The method for producing liquid candle dye according to claim 5, comprising: putting the soaked mixture in step 2 into the stirring device for stirring and then filtering, and putting the filtered mixture into a grinder for grinding.

9. The method for producing liquid candle dye according to claim 6, comprising: putting the soaked mixture in step 2 into the stirring device for stirring and then filtering, and putting the filtered mixture into a grinder for grinding.

10. The method for producing liquid candle dye according to claim 7, comprising: putting the soaked mixture in step 2 into the stirring device for stirring and then filtering, wherein a temperature during stirring is maintained at 60° and a stirring time is 1.5 to 3.5 hours.

11. The method for producing liquid candle dye according to claim 8, comprising: putting the soaked mixture in step 2 into the stirring device for stirring and then filtering, wherein a temperature during stirring is maintained at 60° and a stirring time is 1.5 to 3.5 hours.

12. The method for producing liquid candle dye according to claim 9, comprising: putting the soaked mixture in step 2 into the stirring device for stirring and then filtering, wherein a temperature during stirring is maintained at 60° and a stirring time is 1.5 to 3.5 hours.

13. The method for producing liquid candle dye according to claim 3, wherein in step 2, the oil-soluble dye is in the solvent for 2 to 5 hours.
